(19) United States
(12) Patent Application Publication
(10) Pub. No.: US 2018/0359759 A1
(43) Pub. Date: Dec. 13, 2018

(54) WIRELESS SIGNAL TRANSMISSION APPARATUS AND METHOD FOR USING NON-LICENSED BAND

(71) Applicant: SK TELECOM CO., LTD., Seoul (KR)

(72) Inventors: Chang-soon CHOI, Seoul (KR); Minsoo NA, Seoul (KR)

(21) Appl. No.: 15/772,168

(22) PCT Filed: Jun. 28, 2016
(86) PCT No.: PCT/KR2016/006902

§ 371 Date: Apr. 30, 2018

(30) Foreign Application Priority Data
Oct. 30, 2015 (KR) 10-2015-0152029

(51) Int. Cl. H04W 72/08; H04W 72/04; H04W 74/08

(52) U.S. Cl. CPC H04W 72/082; H04W 74/0808; H04W 72/0453

(57) ABSTRACT

The present disclosure in some embodiments selects some channels that may include the maximum frequency bandwidth of a radio signal, from a plurality of channels of an unlicensed band, and applies a license-assisted access method to some channels. Some embodiments provide a radio signal transmission apparatus and method for effectively avoiding narrowband interference between a Wi-Fi signal and a radio signal having a maximum frequency bandwidth wider than that of the Wi-Fi signal.

### CROSS-REFERENCE TO RELATED APPLICATION

This application claims priority under 35 U.S.C §119(a) of Patent Application No. 10-2015-0152029, filed on Oct. 30, 2015 in Korea, the entire content of which is incorporated herein by reference. In addition, this non-provisional application claims priority in countries, other than the U.S., with the same reason based on the Korean patent application, the entire content of which is hereby incorporated by reference.

### TECHNICAL FIELD

The present disclosure in some embodiments relates to an apparatus and a method of transmitting a radio signal for using an unlicensed band.

### BACKGROUND

The statements in this section merely provide background information related to the present disclosure and do not necessarily constitute prior art.

The frequency bands in which radio signals are used are divided into licensed bands and unlicensed bands. The license band is a frequency band authorized by the country by telecommunications carriers paying expenses. The unlicensed band is a frequency band available for free use at no cost requiring no authorization from the country. The 5 gigahertz (GHz) band out of the unlicensed band is mainly used by Wireless Fidelity (WiFi) signals.

3GPP and other standardization bodies are in recent discussions of license-assisted access (LAA) technology using unlicensed bandwidth to transmit Long Term Evolution (LTE) signals for the 4th generation mobile communication. The LAA technology is a wireless transmission technology that aggregates carriers of the license band and of the unlicensed band and uses the unlicensed band as the supplementary band.

When a communication carrier transmits a long-term evolution signal using an unlicensed band, interference occurring in the unlicensed band between the Wi-Fi signal and the long-term evolution signal becomes an issue. The interference between signals is overshadowed by inability to transmit wireless LAN signals. These deficiencies are due to the different communication methods used between the Wi-Fi signal and the long-term evolution signal.

The communication of the Wi-Fi signal uses a Carrier Sense Multiple Access (CSMA) scheme in order to suppress competition for limited radio resources. This method detects, before transmitting a signal, a carrier wave and checks whether a channel is occupied or not. If the channel is in use, it holds a transmission of radio signal, and if the channel is not in use, performs the transmission. This method is also called a listen before talk (LBT) scheme.

The communication of long-term evolution signals uses an Orthogonal Frequency Division Multiplexing (OFDM) scheme. In this scheme, a signal is modulated into a plurality of narrowband subcarriers orthogonal to each other, which are then multiplexed. Without a channel detecting process, multiple users can transmit radio signals at the same time. Therefore, as long as the long-term evolution signal uses the channel, the Wi-Fi signal has to wait, failing to make a radio transmission.

In order to solve these deficiencies, telecommunications carriers attempt to use the license-assisted access (LAA) method to transmit long-term evolution signals using unlicensed bandwidth. Here, the License-Assisted Access method is an application of the listen before talk (LBT) scheme to the long-term evolution (LTE) signals.

Telecommunications carriers are trying to use signals of the 5th generation mobile communication, at its commencement of standardization, in the unlicensed band. However, there is an obstacle to using the 5th generation mobile communication signal immediately in the unlicensed band. The maximum frequency bandwidth of the 4th generation mobile communication signal is narrower than or equal to that of the Wi-Fi signal. Whereas, the maximum frequency bandwidth of the 5th generation mobile communication signal is likely to be wider than or equal to that of the Wi-Fi signal.

The license-assisted access (LAA) method is implemented on the premise that the maximum frequency bandwidth of the mobile communication signal is narrower than or equal to that of the Wi-Fi signal, and it cannot process the mobile communication signal with the wider maximum frequency band than the Wi-Fi signal.

No radio signal transmission apparatus and method for using the unlicensed band have been implemented yet to solve the above-mentioned deficiencies.

### DISCLOSURE

### Technical Problem

The inventors of the present disclosure recognize the problem that using an unlicensed band between the radio signals having different maximum frequency bandwidths causes narrowband interference between the radio signals, and seek to apply the license-assisted access method to only part of the radio signal, which has wide maximum frequency bandwidth.

Embodiments of the present disclosure select some channels that may include the maximum frequency bandwidth of a radio signal from among a plurality of channels in the unlicensed band, and apply the license-assisted access method to some channels, and thereby effectively avoid the narrow band interference between the Wi-Fi signals and the radio signals having the maximum frequency bandwidth wider than that of the Wi-Fi signals.

Other objects not described in the present disclosure can be further considered within the range that can easily be deduced from the detailed description below and its effects.

### SUMMARY

An aspect of the present embodiment provides a radio signal transmission apparatus for using a first frequency band or a second frequency band or both while avoiding interference between a first radio signal that is a radio signal having a first maximum frequency bandwidth and a second radio signal that is a radio signal having a second maximum frequency bandwidth. The radio signal transmission apparatus includes a channel selection unit, an available channel determination unit, and a radio signal transmission unit. The channel selection unit is configured to select, from a plurality of channels in the second frequency band, M (a natural number) channels that compose at least a part of the first maximum frequency bandwidth. The available channel determination unit is configured to determine concurrently or nonconcurrently whether at least one channel of the M channels is being occupied by the first radio signal or the second radio signal. The radio signal transmission unit is configured to transmit the first radio signal to a radio signal reception apparatus by using the first frequency band or the at least one channel or both when the at least one channel is not being occupied by the first radio signal and the second radio signal. Here, the first maximum frequency bandwidth is wider than or equal to the second maximum frequency bandwidth.

Another aspect of the present disclosure provides a method of transmitting, by a radio signal transmission apparatus, a radio signal, for using a first frequency band or a second frequency band or both while avoiding interference between a first radio signal that is a radio signal having a first maximum frequency bandwidth and a second radio signal that is a radio signal having a second maximum frequency bandwidth. The method includes selecting, from a plurality of channels in the second frequency band, M (a natural number) channels that compose at least a part of the first maximum frequency bandwidth, and determining concurrently or nonconcurrently whether at least one channel of the M channels is being occupied by the first radio signal or the second radio signal, and transmitting the first radio signal to a radio signal reception apparatus by using the first frequency band or the at least one channel or both when the at least one channel is not being occupied by the first radio signal and the second radio signal. Here, the first maximum frequency bandwidth is wider than or equal to the second maximum frequency bandwidth.

### Advantageous Effects

As described above, according to some embodiments of the present disclosure, some channels can be selected that may include the maximum frequency bandwidth of the radio signal from among a plurality of channels of the unlicensed band, and the license-assisted access method can be applied to some channels, and thereby effectively avoid the narrow band interference between the Wi-Fi signals and the radio signals having the maximum frequency bandwidth wider than that of the Wi-Fi signals.

Embodiments of the present disclosure can apply the License-Assisted Access method to some channels among a plurality of channels of the unlicensed band, by selecting some channels that may include the maximum frequency bandwidth of the radio signal.

According to some embodiments of the present disclosure, by applying the license-assisted access method to some channels selected from a plurality of channels of the unlicensed band concurrently or nonconcurrently, the narrow band interference between the Wi-Fi signals and the radio signals may be effectively avoided where radio resources are variable.

While using some channels, embodiments of the present disclosure make a second determination of whether other channels are available and use the other available channels, and thereby utilize a plurality of channels efficiently timewise.

Some embodiments of the present disclosure make a second determination of whether used channels are available and reuse the available channels used or notify a radio resource scheduling unit of the channel status information, thereby effecting the maximized efficiency of use of the radio resources.

Other effects that are explained or suggested below in the specification and their tentative effects are included, even though not explicitly stated in this section.

### BRIEF DESCRIPTION OF THE DRAWINGS

FIG. 1 is a block diagram of a radio signal transmission apparatus according to at least one embodiment of the present disclosure.

FIG. 2 is a flowchart of a radio signal transmission method according to at least one embodiment of the present disclosure.

FIGS. 3 to 6 are diagrams illustrating a plurality of channels in a second frequency band according to at least one embodiment of the present disclosure.

### REFERENCE NUMERALS

100: Radio signal transmission apparatus
200: Radio signal reception apparatus
110: Channel selection unit
120: Available channel determination unit
130: Radio signal transmission unit
300, 400, 500, 600: Channel information of the second frequency band from the perspective of a first radio signal
320, 420, 520, 620: Channel information of the second frequency band from the perspective of a second radio signal
310, 410, 510, 610: Orthogonal frequency division multiplexing subcarriers

### DETAILED DESCRIPTION

Hereinafter, some embodiments of the present disclosure will be described in detail with reference to the accompanying drawings with a detailed description of known functions and configurations incorporated herein being omitted for the purpose of clarity and for brevity.

The embodiments described herein may be used in a wireless communication system.

The wireless communication system includes at least one base station (BS) and at least one terminal (User Equipment or UE). Each base station provides a communication service to a cell which is a specific geographical area. The cell may be subdivided into sectors which are a large number of regions. The communication from the base station to the terminal is called a downlink communication or simply downlink, and the communication from the terminal to the base station is called an uplink communication or simply uplink.

A base station is a station that communicates with a terminal and can be referred to as another name such as an evolved-Node B (eNB), a base transceiver system (BTS) and an access point.

A terminal is an apparatus which communicates with a network, and it may be referred to by another name including a mobile station (MS), a mobile terminal, a user terminal (UT), a subscriber station (SS), a wireless device, a portable information terminal (Personal Digital Assistant or PDA), a wireless modem and a handheld device among others.

Various multiple access transmission technologies may be applied to the wireless communication system. Multiple-access is a technology for multiple users to jointly use code, frequency, time, space, etc. Multiple-access may be divided into a fixed allocation approach and a dynamic allocation approach.

Examples of fixed allocation approaches include Code Division Multiple Access (CDMA), Frequency Division Multiple Access (FDMA), Time Division Multiple Access (TDMA), Orthogonal Frequency Division Multiple Access (OFDMA) scheme, and the like, but the present disclosure is not limited thereto.

An example of the dynamic allocation approach is Carrier Sense Multiple Access (CSMA) method, but the present disclosure is not limited thereto.

Various duplexing technologies for bidirectional communication may be applied to the wireless communication system. Examples of duplexing technologies include but not limited to frequency division duplexing (FDD), time division duplexing (TDD), and the like.

A multiple antenna technology may be applied to the wireless communication system. Based on the configuration of the antennas, multi-antenna types may be classified into single-input (source transmitter) single-output (destination receiver) (SISO), single-input multiple-output (SIMO), multiple-input single-output (MISO) and multiple-input multiple-output (MIMO). The input transmit antenna refers to a physical or logical antenna used to transmit a single signal or stream. The output receive antenna means a physical or logical antenna used to receive a single signal or stream.

A wireless communication system may use a single bandwidth for signal transmission. For example, the second generation mobile communication signal uses a bandwidth of from 200 kilohertz (kHz) to 1.25 megahertz (MHz). The third generation mobile communication signal uses a bandwidth of from 5 MHz to 10 MHz. The 4th generation mobile communication signal uses 20 MHz.

When a wireless communication system is to transmit a mobile communication signal in a frequency band in which a wireless LAN signal is transmitted, interference may occur between the mobile communication signal and a wireless LAN signal. In particular, when the bandwidth of the mobile communication signal is different from that of the wireless LAN signal, it is necessary to provide a radio signal transmission apparatus for effectively dealing with the narrow band interference due to the difference in the bandwidth.

Hereinafter, a radio signal transmission apparatus capable of effectively taking care of interference between a mobile communication signal and a wireless LAN signal will be described. Here, the radio signal transmission apparatus may be implemented as a part of a wireless communication system.

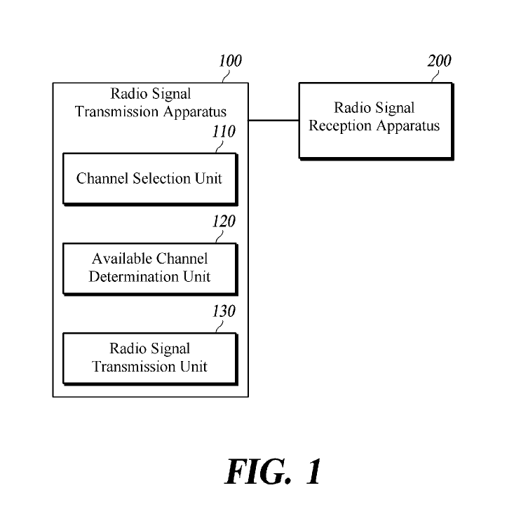

FIG. 1 is a block diagram illustrating a radio signal transmission apparatus according to an embodiment of the present disclosure. As shown in FIG. 1, the radio signal transmission apparatus 100 according to at least one embodiment includes a channel selection unit 110, an available-channel determination unit 120, a radio signal transmission unit 130.

The radio signal transmission apparatus 100 is a device that transfers a radio signal, for example, a mobile communication signal, to a radio signal reception apparatus 200. The radio signal transmission apparatus 100 is linked with the radio signal reception apparatus 200. The radio signal transmission apparatus 100 may be a base station of a wireless communication system, and the radio signal reception apparatus 200 may be a terminal of a wireless communication system, and vice versa. For convenience of explanation, the process of downlink transmission of the radio signal by the radio signal transmission apparatus 100 will be described as an example, but it is also applicable to the uplink transmission.

The radio signal transmission apparatus 100 transmits a radio signal having a first maximum frequency bandwidth (hereinafter referred to as a first radio signal) by using the first frequency band or the second frequency band or both. The radio signal transmission apparatus 100 selects several channels from a plurality of channels in the second frequency band, and applies the license-assisted access (LAA) scheme to some channels. This enables to avoid interference between the first radio signal and a radio signal having a second maximum frequency bandwidth (hereinafter referred to as a second radio signal).

The first radio signal may be, but not limited to, a fourth generation mobile communication signal or a fifth generation mobile communication signal, and the second radio signal may be, but not limited to, a wireless LAN (Wireless Fidelity or Wi-Fi) signal.

The first radio signal may operate by an orthogonal frequency division multiplexing (OFDM) scheme in the first frequency band or the second frequency band or both, and the second radio signal may operate by a carrier sense multiple access (CSMA) scheme in the second frequency band, but they are not limited to this.

The first frequency band may be, but not limited to, a licensed band, and the second frequency band may be, but not limited to, an unlicensed band that is the 5 gigahertz (GHz) band.

The first maximum frequency bandwidth may be wider than or equal to the second maximum frequency bandwidth. For example, although not limited thereto, the first maximum frequency bandwidth may be 100 MHz and the second maximum frequency bandwidth may be 20 MHz.

The channel selection unit 110 is configured to select some channels from a plurality of channels in the second frequency band. The channel selection unit 110 selects, from the plurality of channels, M channels (M is a natural number) that compose at least some of the first maximum frequency bandwidth. For example, five channels may be selected when the first maximum frequency bandwidth is 100 MHz and the bandwidth of a channel is 20 MHz. Meanwhile, the channel selection unit 110 may also select one to four channels.

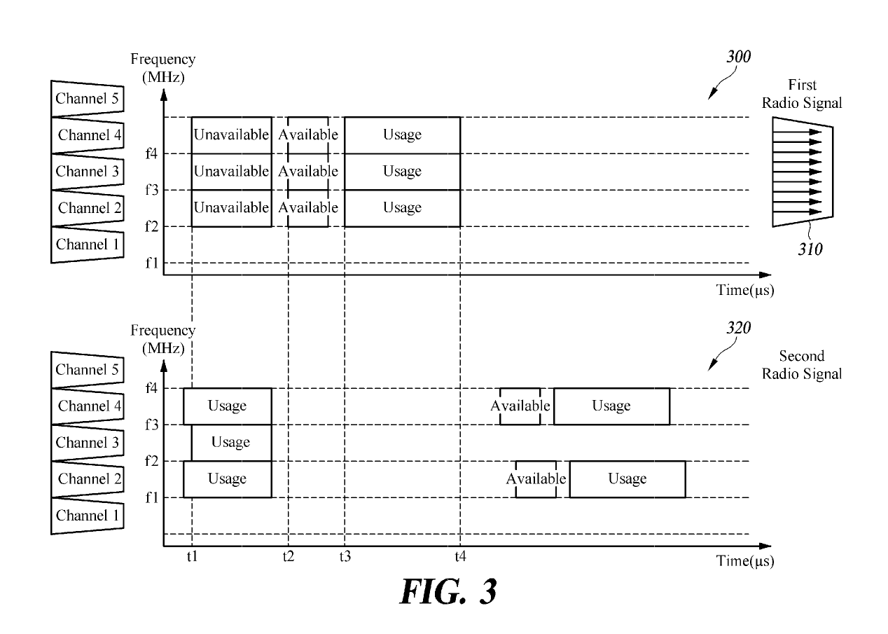

From the plurality of channels in the second frequency band, the channel selection unit 110 may select M consecutive channels (M is a natural number) that compose at least some of the first maximum frequency bandwidth. For example, referring to FIG. 3, continuous channels 2 to 4 may be selected from consecutive channels 1 to 5. Alternatively, the selection unit 110 may select a discontinuous channel. For example, it may select discontinuous channel 1, channel 3, and channel 4 from the continuous channels 1 to 5.

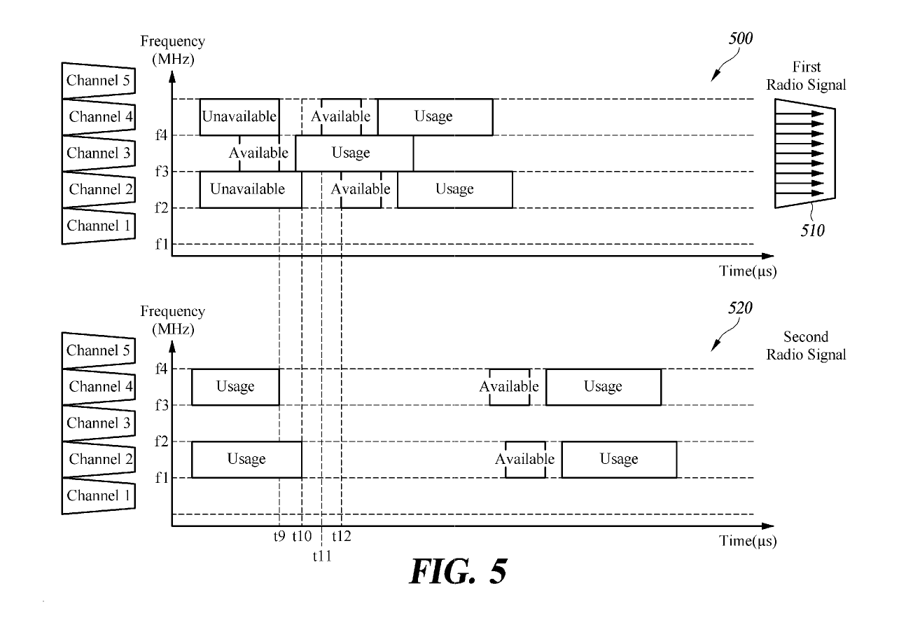

An available channel determination unit 120 is adapted to determine whether or not a channel is available for use out of a plurality of channels in the second frequency band. The available channel determination unit 120 determines whether or not at least one channel of the selected M channels is in use by the first radio signal or the second radio signal. The available channel determination unit 120 may determine concurrently or nonconcurrently whether at least one channel is being used. For example, referring to FIG. 3, the available channel determination unit 120 may determine whether three channels (channels 2 to 4) are being used by a first radio signal or a second radio signal concurrently (at time t2). On the other hand, referring to FIG. 5, the available channel determination unit 120 may make determination on the channels 4 and 2 nonconcurrently (at time t11 and at time t12), respectively.

In case where the first radio signal fails to use at least one channel, the available channel determination unit 120 determines that at least one channel is in use by the second radio signal or the second radio signal after a preset available channel determination period.

An available channel determination period is the period for redetermining whether or not a channel is in use. The available channel determination cycle is set in advance. The available channel determination period may be an arbitrary numerical value estimated based on the communication data or a numerical value according to the technical provision. The available channel determination period may be changed as a numerical value set according to the design of the system. For example, referring to FIG. 5, the available channel determination period is the time span from time t9 to time t11. The time span from time t9 to time t11 may be set to be longer than or equal to 20 μs, but it is not limited thereto.

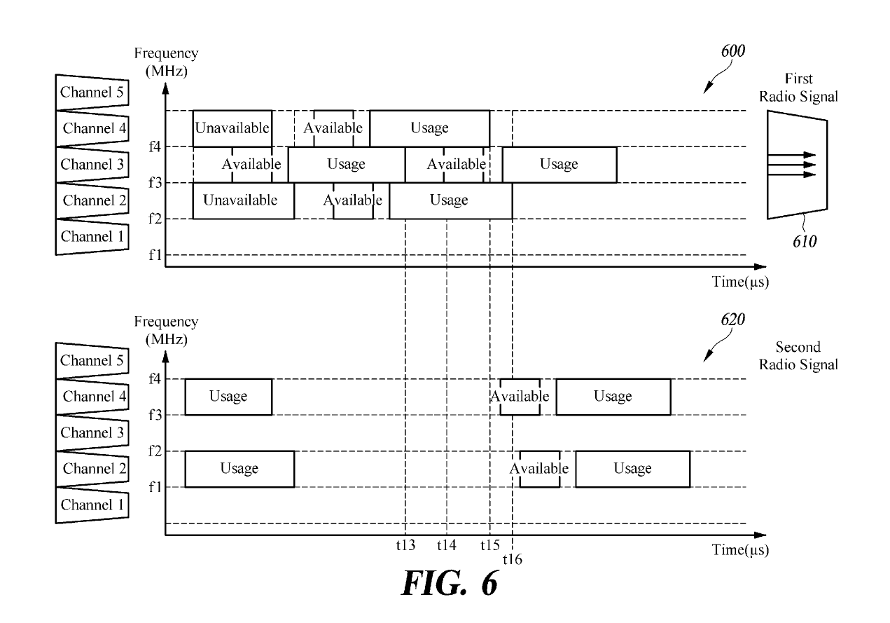

In case where the first radio signal is to successively or intermittently use the very channel that it used for its transmission, the available channel determination unit 120 may determine whether at least one channel is being used by the first radio signal or the second radio signal after a preset channel usage time. For example, referring to FIG. 6, when channel 3, after being used for the transmission of the first radio signal, is to be successively used, the available channel determination unit 120 may determine whether channel 3 is in use by the first radio signal or the second radio signal.

The channel usage time is the time set so that the first radio signal or the second radio signal may use the channel. The channel usage time is preset. The channel usage time may be an arbitrary numerical value estimated based on the communication data or a numerical value according to the relevant technical provision. The channel usage time may be changed as a numerical value set according to the design of the system. For example, referring to FIG. 3, the channel usage time is the time span from time t3 to time t4. The time from time t3 to time t4 may be set from 1 millisecond (ms) to 10 ms, although the present disclosure is not limited thereto.

The radio signal transmission unit 130 is adapted to transmit the first radio signal to the radio signal reception apparatus 200 by using at least one channel of the plurality of channels of the second frequency band or the first frequency band or both. When at least one channel of the second frequency band is not in use by the first radio signal and the second radio signal, the radio signal transmission unit 130 transmits the first radio signal to the radio signal reception apparatus 200. The radio signal transmission unit 130 utilizes the at least one channel of the second frequency band or the first frequency band or both as determined by the usable channel determination unit 120 to transmit the first radio signal to the radio signal reception apparatus 200.

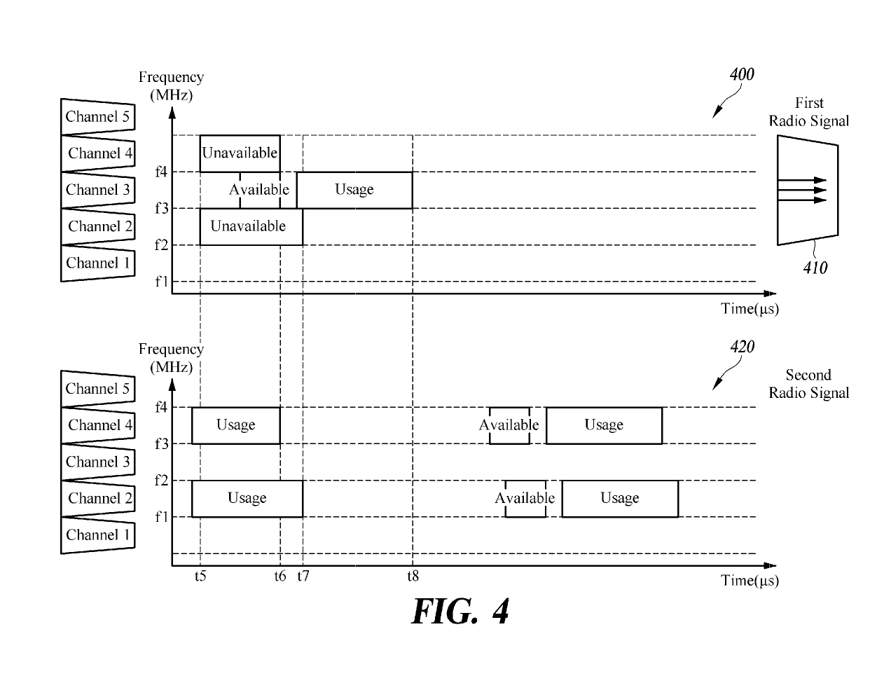

As shown in FIG. 3, three channels (channels 2 to 4) are in use by neither the first radio signal nor the second radio signal at time t2, when the radio signal transmission unit 130 may transmit the first radio signal to the radio signal reception apparatus by using the first frequency band and the three channels (the channels 2 to 4). Or, as shown in FIG. 4, the radio signal transmission unit 130 may transmit the first radio signal to the radio signal reception apparatus by using the first frequency band and one channel (channel 3).

The radio signal transmission unit 130 may transmit the first radio signal to the radio signal reception apparatus by aggregating carriers of the first frequency band and/or at least one channel of the second frequency band. Carrier aggregation (CA) is a technology of establishing an increased bandwidth by aggregating one or more component carriers (CCs) having a bandwidth narrower than the wider bandwidth to be provided. Carrier aggregation may be employed between homogeneous or heterogeneous networks. For example, it may be employed between a Long Term Evolution (LTE) frequency and another Long Term Evolution (LTE) frequency, or between a Long Term Evolution (LTE) frequency and a Wireless LAN (Wi-Fi) frequency, although not limited thereto.

The radio signal transmission unit 130 may transmit the first radio signal to the radio signal reception apparatus by using the first frequency band and/or subcarriers of at least one channel. The subcarriers are based on the Orthogonal Frequency Division Multiplexing (OFDM) method. For example, referring to FIGS. 3 to 6, the radio signal transmission unit 130 may use the orthogonal frequency division multiplexing (OFDM) subcarriers (310, 410, 510 and 610) to transmit the first radio signal.

The radio signal transmission apparatus 100 may further include a radio resource scheduling unit (not shown).

The radio resource scheduling unit is provided for optimally allocating limited radio resources to a plurality of users in a cell at each time. The radio resource scheduling unit schedules a resource block by using states of the multiple channels of the first frequency band and/or the multiple channels in the second frequency band. Resource blocks are classified by frequency and time into lattices, and are divided into subblocks. Various scheduling methods may be applied to the radio resource scheduling unit for optimally allocating resource blocks to the multiple users.

In case where the first radio signal is to successively use the same channel as it used for the transmission thereof, the available channel determination unit 120 may inform the radio resource scheduling unit of the state of at least one determined channel. For example, referring to FIG. 6, in the case of successively using channel 3 that was used for the transmission of the first radio signal, the available channel determination unit 120 may provide the status information of channel 3 to the radio resource scheduling unit.

Some embodiments of the present disclosure select some channels that may include the maximum frequency bandwidth of the radio signal from among a plurality of channels of the unlicensed band, and provide the license-assisted access (LAA) to some channels, and thereby effectively avoid the narrow band interference between the Wi-Fi signal and the radio signal having the maximum frequency bandwidth wider than that of the Wi-Fi signal.

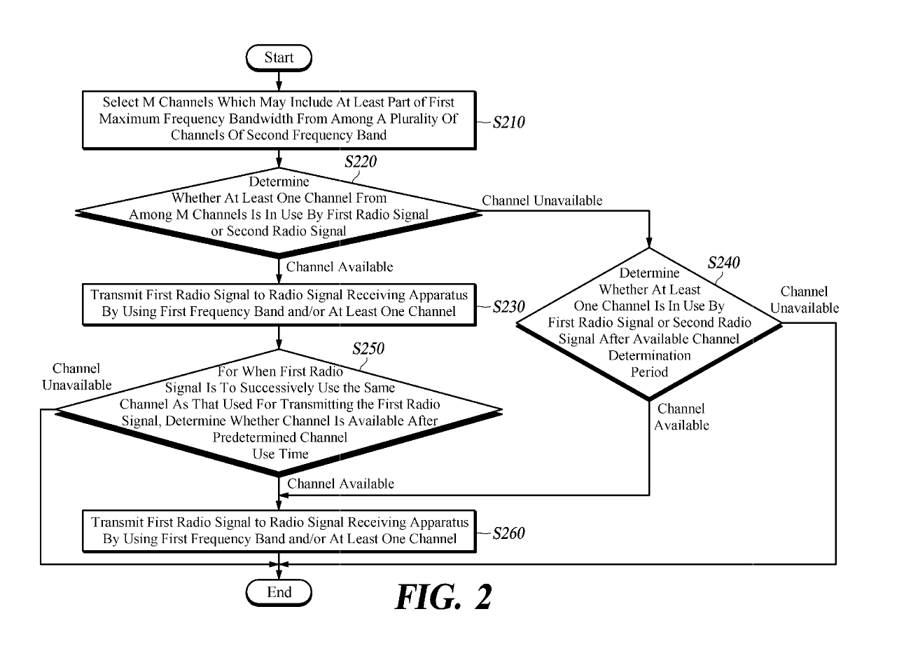

The following will describe the operation of the radio signal transmission apparatus 100 according to at least one embodiment of the present disclosure. FIG. 2 is a flowchart illustrating a radio signal transmission method according to at least one embodiment of the present disclosure. Referring to FIGS. 3 and 4, Steps S210 through S230 and will be described, and Steps S240 and S260 will be described with reference to FIG. 5, and Steps S250 and S260 will be described with reference to FIG. 6.

In FIGS. 3 at 300 and 320, there are illustrated information on channels of the second frequency band over time. Reference numeral 300 denotes channel information of a second frequency band from the perspective of a first radio signal, and reference numeral 320 denotes channel information of the second frequency band from the perspective of a second radio signal. For convenience of explanation, channel information of the second frequency band is divided by reference numerals 300 and 320, but this indicates the same second frequency band.

The first maximum frequency bandwidth may be wider than or equal to the second maximum frequency bandwidth. For convenience of explanation, it is illustrated that the first maximum frequency bandwidth is 60 MHz and the second maximum frequency bandwidth is 20 MHz as an example, although the values of the first and second maximum frequency bandwidths are not limited thereto.

The second frequency band has a plurality of channels. The plurality of channels includes, but not limited to, example channels 1 to 5. The bandwidth of each channel may be 20 MHz, although not limited thereto. Frequencies f1 to f4 exemplify the frequencies that are boundaries of the respective channels of the second frequency band.

In Step S210, the radio signal transmission apparatus 100 selects, from among the plurality of channels of the second frequency band, M channels (M is a natural number) that compose at least a part of the first maximum frequency bandwidth. Referring to FIG. 3, the radio signal transmission apparatus 100 may select channels 2 to 4 from channel 1 to channel 5 at time t1.

Thereby, the radio signal transmission apparatus 100 selects some channels for composing the maximum frequency bandwidth of the radio signal from among the plurality of channels of the unlicensed band, thereby allowing the license-assisted access method to be applied to the selected channels.

In Step S220, the radio signal transmission apparatus 100 determines concurrently or nonconcurrently whether at least one channel among the M channels is used by the first radio signal or the second radio signal. Referring to FIG. 3, the radio signal transmission apparatus 100 may determine whether the channels 2 to 4 are used at time t1. In FIG. 3, the radio signal transmission apparatus 100 may determine whether channels 2 to 4 are being used at time t2.

In Step S230, unless at least one channel is in use by the first radio signal or the second radio signal, the radio signal transmission apparatus 100 transmits the first radio signal to the radio signal reception apparatus by using the first frequency band or at least one channel of the second frequency band or both. Referring to FIG. 3, channels 2 to 4 are not used at time t2, so that the first radio signal may use channels 2 to 4 from time t3 to time t4. The time span from time t3 to time t4 is the channel usage time which may be set to be 1 ms to 10 ms, although not limited thereto.

In Step S230, the radio signal transmission apparatus 100 may transmit the first radio signal by using the first frequency band and/or subcarriers 310 of channels 2 to 4 of the second frequency band. The subcarrier 310 based on orthogonal frequency division multiplexing may be used for transmission of the first radio signal. After time t4, upon determining, by the apparatus for transmitting the second radio signal, whether channels 2 and 4 are available for use, the second radio signal uses channel 2 and channel 4.

As a result, the radio signal transmission apparatus 100 selects some channels that may include the maximum frequency bandwidth of the radio signal from among the plurality of channels in the unlicensed band, thereby permitting the license-assisted access method to be applied to the selected channels.

Different from the information on the channels of the second frequency band described with reference to FIG. 3, the information on the channels of the second frequency band exemplified in FIG. 4 illustrates a case where the radio signal transmission apparatus 100 determines nonconcurrently whether a plurality of channels is usable or not, and utilizes only some channels.

Referring to FIG. 4, the radio signal transmission apparatus 100 may determine whether the channel 2 and the channel 4 are used at time t5. From time t5 to time t6, channels 2 and 4 are used by the second radio signal. On the other hand, channel 3 is not used from time t5 to time t6 by the second radio signal.

Referring to FIG. 4, as a result of Step S220 determining the positive availability of channel 2 from among channels 2 to 4 because it is not in use by the first radio signal or the second radio signal, the radio signal transmission apparatus 100 may transmit the first radio signal by using the channel 2. The time span from time t7 to time t8 is the channel usage time which may be set to be 1 ms to 10 ms, although not limited thereto.

Referring to FIG. 4, in Step S230, the radio signal transmission apparatus 100 may transmit the first radio signal by using the first frequency band and/or the subcarrier 410 of channel 2 of the second frequency band. The subcarrier 410 based on orthogonal frequency division multiplexing may be used for transmission of the first radio signal.

As a result, the radio signal transmission apparatus 100 applies concurrently or nonconcurrently the license-assisted access method to some channels selected from a plurality of channels of the unlicensed band, whereby the narrow band interference can be effectively avoided between the radio signal and the Wi-Fi signal where wireless resources are variable.

In Step S240, in case where the first radio signal has not used at least one channel, the radio signal transmission apparatus 100 determines whether at least one channel is in use after a preset available channel determination period by the first radio signal or the second radio signal.

In Step S260, in case where at least one channel is not used by the first radio signal or the second radio signal, the radio signal transmission apparatus 100 transmits the first radio signal to the radio signal reception apparatus by using the first frequency band and/or at least one channel of the second frequency band. On the other hand, when at least one channel is being used by the first radio signal or the second radio signal, the radio signal transmission apparatus 100 does not use such channel that it considered in determining the channel availability for transmitting the first radio signal.

Different from the information on the channels of the second frequency band described with reference to FIG. 4, the information on the channels of the second frequency band exemplified in FIG. 5 represents that the radio signal transmission apparatus 100 uses the channel it has missed to use after redetermining the availability thereof.

Referring to FIG. 5, channel 4 is used by the second radio signal up until time t9, and channel 2 is used by the second radio signal up to time t10. The radio signal transmission apparatus 100 may redetermine whether or not the channel 4 is used at time t11. The radio signal transmission apparatus 100 may redetermine whether or not the channel 2 is being used at time t12. The time span from time t9 to time t11 and the time span from time t10 to time t12 may be set as the usable channel determination period, such as 20 μs or more, although not limited thereto. Although not shown in FIG. 5, when the channel 2 is used by the second radio signal at time t12, the radio signal transmission apparatus 100 does not use channel 2 in transmitting the first radio signal.

Referring to FIG. 5, the radio signal transmission apparatus 100 in Step S260, may transmit the first radio signal by using the first frequency band and/or the subcarrier 510 of channel 2 to channel 4. The subcarrier 510, which is based on orthogonal frequency division multiplexing, may be used for transmission of the first radio signal. When Step S240 determines the availability of channel 2 and channel 4 concluding that channel 2 or channel 4 is used by the first radio signal or the second radio signal, the radio signal transmission apparatus 100 does not use channel 2 and channel 4, which are being used.

As a result, while using some channels to transmit the first radio signal, the radio signal transmission apparatus 100 redetermines whether another channel is available and uses the same, thereby efficiently using multiple channels in terms of time.

In Step S250, when the first radio signal is to successively use the same channel as that was used for its own transmission, the radio signal transmission apparatus 100 determines whether at least one channel is being used by the first radio signal or the second radio signal after a preset channel usage time.

In Step S260, when at least one channel is not being used by the first radio signal or the second radio signal, the radio signal transmission apparatus 100 transmits the first radio signal to the radio signal reception apparatus by using the first frequency band and/or at least one channel of the second frequency band. When Step S250 determines the availability of channel 3 concluding it is used by the first radio signal or the second radio signal, the radio signal transmission apparatus 100 does not use channel 3 considered in determining the channel availability for transmitting the first radio signal.

Different from the information on the channels of the second frequency band described with reference to FIG. 5, the information on the channels of the second frequency band exemplified in FIG. 6 illustrates a case where the radio signal transmission apparatus 100 redetermines the availability of the channel used once and uses the same.

Referring to FIG. 6, channel 3 is used by the first radio signal up until time t13, channel 4 is used by the first radio signal up to time t15, and channel 2 is used by the first radio signal up to time t16. The radio signal transmission apparatus 100 may redetermine whether or not the channel 3 is used at time t14 after time t13. Here, time t13 is when the channel usage time is terminated.

As a result, the radio signal transmission apparatus 100 redetermines whether or not the channel it used is available to reuse the same or notify the wireless resource scheduling unit of the channel condition information, thereby maximizing the efficiency of using radio resources.

Although FIG. 2 illustrates that the respective steps as being sequentially performed, it merely instantiates a technical idea of some embodiments of the present disclosure. Therefore, a person having ordinary skill in the pertinent art could appreciate that various modifications, additions, and substitutions are possible by changing the sequence illustrated in FIG. 2 or by performing two or more steps in parallel, without departing from the gist and nature of the embodiments of the present disclosure.

The term “unit” or “device” herein used may refer to various apparatuses including all or some of a communication apparatus such as a communication modem for communicating with various devices or wired/wireless communication network, a memory for storing data for executing a program, a microprocessor or the like for executing a program to perform operations and commands. Here, the “unit” or “device” may be implemented in logic circuitry by hardware, firmware, software, or a combination thereof, and may be implemented using a general purpose or special purpose computer. “Unit” or “device” may be implemented by using a hardwired device, a field programmable gate array (FPGA), an application specific integrated circuit (ASIC). In addition, “unit” or “apparatus” may be implemented as a System on Chip (SoC) including one or more processors and controllers.

Exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the explicitly described above embodiments but by the claims and equivalents thereof.

1. A radio signal transmission apparatus for using a first frequency band or a second frequency band or both while avoiding interference between a first radio signal that is a radio signal having a first maximum frequency bandwidth and a second radio signal that is a radio signal having a second maximum frequency bandwidth, the radio signal transmission apparatus comprising:
a channel selection unit configured to select, from a plurality of channels in the second frequency band, M (a natural number) channels that compose at least a part of the first maximum frequency bandwidth;
an available channel determination unit configured to determine concurrently or nonconcurrently whether at least one channel of the M channels is being occupied by the first radio signal or the second radio signal; and
a radio signal transmission unit configured to transmit the first radio signal to a radio signal reception apparatus by using the first frequency band or the at least one channel of the second frequency band or both when the at least one channel is being occupied by neither the first radio signal nor the second radio signal, wherein
the first maximum frequency bandwidth is wider than or equal to the second maximum frequency bandwidth.

2. The radio signal transmission apparatus of claim 1, wherein
the first radio signal is a fourth generation mobile communication signal or a fifth generation mobile communication signal, and
the first frequency band is a licensed band.

3. The radio signal transmission apparatus of claim 1, wherein
the second radio signal is a wireless fidelity (WiFi) signal,
the second maximum frequency bandwidth is 20 megahertz (MHz),
the second frequency band is an unlicensed band of 5 gigahertz (GHz), and
the second radio signal is transmitted in the second frequency band by a Carrier Sense Multiple Access (CSMA) method.

4. The radio signal transmission apparatus of claim 1, wherein the channel selection unit is configured to select, from the plurality of channels of the second frequency band, M (a natural number) channels that are consecutive and compose at least a part of the first maximum frequency bandwidth.

5. The radio signal transmission apparatus of claim 4, wherein
the available channel determination unit is configured to determine concurrently whether or not the M channels are being occupied by the first radio signal or the second radio signal, and
the radio signal transmission unit is configured to transmit the first radio signal to the radio signal reception apparatus by carrier aggregation of the first frequency band and the M channels, when the M channels are being occupied by neither the first radio signal nor the second radio signal.

6. The radio signal transmission apparatus of claim 1, wherein
when the first radio signal has missed to use the at least one channel, the available channel determination unit is configured to determine whether the at least one channel is being occupied by the first radio signal or the second radio signal after a preset available channel determination period.

7. The radio signal transmission apparatus of claim 1, wherein
when the first radio signal is to successively or intermittently use the same channel as used for transmitting the first radio signal, the available channel determination unit is configured to determine whether the at least one channel is in use by the first radio signal or the second radio signal after a preset channel usage time.

8. The radio signal transmission apparatus of claim 1, further comprising:
a radio resource scheduling unit configured to schedule a resource block based on states of a plurality of channels of the first frequency band or the plurality of channels of the second frequency band or both.

9. The radio signal transmission apparatus of claim 8, wherein
when the first radio signal is to successively use the same channel as used for transmission of the first radio signal, the available channel determination unit is configured to inform the radio resource scheduling unit of the state of the at least one channel.

10. The radio signal transmission apparatus of claim 1, wherein the radio signal transmission unit is configured to transmit the first radio signal to the radio signal reception apparatus by carrier aggregation of the first frequency band or the at least one channel or both.

11. The radio signal transmission apparatus of claim 1, wherein the radio signal transmission unit is configured to transmit the first radio signal to the radio signal reception apparatus by using the first frequency band or a subcarrier of the at least one channel or both.

12. A method of transmitting, by a radio signal transmission apparatus, a radio signal, for using a first frequency band or a second frequency band or both while avoiding interference between a first radio signal that is a radio signal having a first maximum frequency bandwidth and a second radio signal that is a radio signal having a second maximum frequency bandwidth, the method comprising:
selecting, from a plurality of channels in the second frequency band, M (a natural number) channels that compose at least a part of the first maximum frequency bandwidth;
determining concurrently or nonconcurrently whether at least one channel of the M channels is being occupied by the first radio signal or the second radio signal; and
transmitting the first radio signal to a radio signal reception apparatus by using the first frequency band or the at least one channel of the second frequency band or both when the at least one channel is being occupied by neither the first radio signal nor the second radio signal,
wherein the first maximum frequency bandwidth is wider than or equal to the second maximum frequency bandwidth.

13. The method of claim 12, further comprising:
when the first radio signal has missed to use the at least one channel, determining whether the at least one channel is being occupied by the first radio signal or the second radio signal after a preset available channel determination period.

14. The method of claim 12, further comprising:
when the first radio signal is to successively or intermittently use the same channel as used for transmitting the first radio signal, determining whether the at least one channel is being occupied by the first radio signal or the second radio signal after a preset channel usage time.

15. The method of claim 13, further comprising:
when the at least one channel is being occupied by neither the first radio signal nor the second radio signal, transmitting the first radio signal to the radio signal reception apparatus by using the first radio signal or the at least one channel or both.
